(19) United States
(12) Patent Application Publication
(10) Pub. No.: US 2025/0363535 A1
(43) Pub. Date: Nov. 27, 2025

(54) EMOTIONAL ART SERVICE PROVISION SYSTEM FOR SIGNAGE

(71) Applicant: ALTSOFT. INC., Seoul (KR)

(72) Inventor: Chan Hong KIM, Seoul (KR)

(21) Appl. No.: 18/875,121

(22) PCT Filed: Apr. 9, 2023
(86) PCT No.: PCT/KR2023/004771

§ 371 Date: Dec. 14, 2024

(30) Foreign Application Priority Data
Jun. 15, 2022 (KR) 10-2022-0072786

(51) Int. Cl. G06Q 30/0601

(52) U.S. Cl. CPC G06Q 30/0601

(57) ABSTRACT

Proposed is an emotional art service provision system for a signage device, wherein emotional art, which is digital objects expressing users' emotions by using graphics, is on sale for use on the signage device, and the emotional art purchased by users is controlled to be output to the signage device at the users' requests, so that the signage device may share the users' emotions effectively through the emotional art, the users may have fun purchasing and using various pieces of emotional art, and the emotional art service provision system may serve as a revenue model targeting the users in the operation of the signage device.

### TECHNICAL FIELD

The present disclosure relates to an emotional art service provision system for a signage device. More particularly, the present disclosure relates to an emotional art service provision system for a signage device, the system providing emotional art, which is digital objects expressing users' emotions by using graphics, for use in the signage device.

### BACKGROUND ART

A signage device is a communication tool that can induce marketing and advertising effects, and customer experiences for businesses. The signage device is an image display device that is installed in public spaces or commercial spaces to provide various information and advertisements in real time. In particular, a digital signage device uses digital technology to display an image and information on a display screen and provides a comprehensive management platform that can be remotely controlled over a network.

The signage device is primarily installed outdoors, in subway stations, and public places, but recently, the installation locations have become more diverse, including restaurants, cafes, and apartment elevators. However, the purpose of the signage device has not significantly expanded beyond its role as an advertising board.

As a technology to overcome these limitations, disclosed is Korean Patent No. 10-2386273 (title of invention: SIGNAGE SYSTEM THAT WORKS IN CONJUNCTION WITH USER TERMINALS, registration date: 8 Apr. 2022).

In the meantime, users who are familiar with using the Internet are accustomed to expressing their emotions through visual media, such as images, emojis, and video, rather than written words. That is, the users often express their emotions quickly and effectively by appropriately using visual media that expresses emotions, feelings, or situations in a compressed way, rather than lengthy descriptions of emotions. However, the visual media is mostly serviced for use on personal terminals, so there are limitations that the visual media cannot be applied to a signage device.

### DISCLOSURE

### Technical Problem

The present disclosure has been made keeping in mind the above problems occurring in the previously proposed methods, and the present disclosure is directed to providing an emotional art service provision system for a signage device, wherein emotional art, which is digital objects expressing users' emotions by using graphics, is on sale for use on the signage device, and the emotional art purchased by users is controlled to be output to the signage device at the users' requests, so that the signage device may share the users' emotions effectively through the emotional art, the users may have fun purchasing and using various pieces of emotional art, and the emotional art service provision system may serve as a revenue model targeting the users in the operation of the signage device.

### Technical Solution

In order to achieve the above objective, according to one aspect of the present disclosure, there is provided an emotional art service provision system for a signage device,
wherein the emotional art service provision system enables individual users exposed to the signage device to share content to the signage device and provides emotional art, which is digital objects expressing the users' emotions by using graphics, for use in the signage device, the emotional art service provision system including:
the signage device configured to output the content including the emotional art through a display panel thereof;
a service server configured to store emotional art data created for the signage device, sell the emotional art through an online shop, and perform control so that the emotional art purchased by the users is output to the signage device at the users' requests; and
user terminals configured to purchase the emotional art and request the signage device to output the emotional art,
wherein the service server includes:
a database part configured to store the emotional art data;
a shop operation part configured to operate the online shop selling the emotional art; and
a signage device management part configured to control transmission so that the emotional art purchased by the user terminals accessing the online shop is output from the signage device at the users' requests,
the signage device is configured to
output the content uploaded by the users for sharing, and share the users' emotions through the emotional art.

Preferably, the service server
may further include an editing part configured to provide an editing tool for creating the content, and edit the emotional art purchased by the users, through the editing tool.

More preferably, the editing part may be configured to
edit a preset editable configuration of the emotional art.

Preferably, the service server
may further include an emotional art registration part configured to receive and verify user-created emotional art to register the user-created emotional art as a product in the online shop operated by the shop operation part.

Preferably, the database may be configured to
store the emotional art data by classifying the emotional art data into categories including a size of the emotional art and an event type.

Preferably, the emotional art may be
still or animated digital objects.

Preferably, the signage device management part may be configured to
receive, from the user terminals, selection of the emotional art to be shared and of the signage device to which the emotional art is to be output, and control transmission so that the emotional art is output from the signage device when the users have rights to share the content to the signage device.

More preferably, the signage device may be configured to
output the content in order of creation or in order of popularity or both.

### Advantageous Effects

According to an emotional art service provision system for a signage device proposed in the present disclosure, emotional art, which is digital objects expressing users' emotions by using graphics, is on sale for use on the signage device, and the emotional art purchased by users is controlled to be output to the signage device at the users' requests, so that the signage device may share the users' emotions effectively through the emotional art, the users may have fun purchasing and using various pieces of emotional art, and the emotional art service provision system may serve as a revenue model targeting the users in the operation of the signage device.

### DESCRIPTION OF DRAWINGS

FIG. 1 is a diagram illustrating the configuration of an emotional art service provision system for a signage device according to an embodiment of the present disclosure.

FIG. 2 is a diagram illustrating a detailed configuration of a service server, in an emotional art service provision system for a signage device according to an embodiment of the present disclosure.

FIG. 3 is a diagram illustrating an example of an online shop operated by a shop operation part of an emotional art service provision system for a signage device according to an embodiment of the present disclosure.

FIG. 4 is a diagram illustrating an example of a display screen of a signage device in which content is output, in an emotional art service provision system for a signage device according to an embodiment of the present disclosure.

FIG. 5 is a diagram illustrating an example of a display screen of a signage device in which a piece of emotional art is displayed enlarged, in an emotional art service provision system for a signage device according to an embodiment of the present disclosure.

### DESCRIPTION OF THE REFERENCE NUMERALS IN THE DRAWINGS

100: signage device
200: service server
210: database part
220: shop operation part
230: signage device management part
240: editing part
250: emotional art registration part
300: user terminal

### BEST MODE

Hereinafter, preferred embodiments of the present disclosure will be described in detail with reference to the accompanying drawings such that the present disclosure can be easily embodied by those skilled in the art to which the present disclosure belongs. However, in describing the preferred embodiments of the present disclosure in detail, if it is decided that a detailed description of the known function or configuration related to the present disclosure makes the subject matter of the present disclosure unclear, the detailed description will be omitted. In addition, throughout the drawings, the same reference numerals are used for parts having similar functions and operations.

Throughout the specification, when a part is referred to as being “connected” to another part, it includes not only being “directly connected”, but also being “indirectly connected” by interposing the other part therebetween. In addition, when a part “includes” an element, this means that it further includes other elements, but does not exclude other elements, unless specifically stated otherwise.

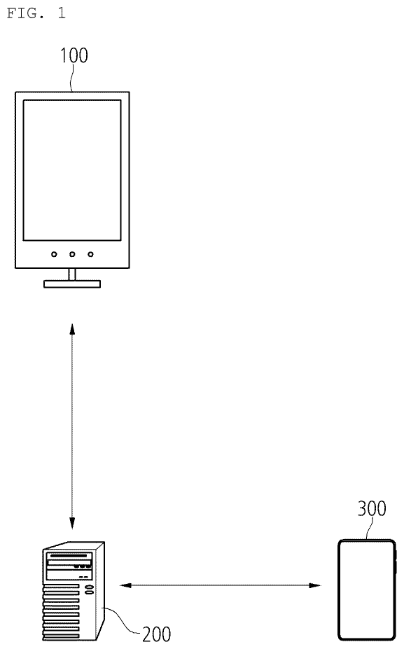

FIG. 1 is a diagram illustrating the configuration of an emotional art service provision system for a signage device 100 according to an embodiment of the present disclosure. As shown in FIG. 1, an emotional art service provision system for a signage device 100 according to an embodiment of the present disclosure is a system that provides emotional art, which is digital objects expressing users' emotions by using graphics, for use in the signage device 100, and may include a signage device 100, a service server 200, and a user terminal 300.

That is, according to the present disclosure, the service server 200 provides emotional art, which is digital objects expressing users' emotions by using graphics, and the users purchase the emotional art and share the emotional art through the signage device 100 to efficiently express their emotions in a compressed way and share their emotions through the emotional art.

Herein, the emotional art may be 2D, 3D still graphics or animated graphics. More specifically, the emotional art may be in a form similar to emojis used in instant messengers or stickers and mobile cards used in social media. The signage device 100 to which the emotional art is output has a display screen that is typically larger than a personal terminal, so the emotional art may be made for a large screen. According to an embodiment, the emotional art may include a plurality of digital objects. The service server 200 sells various pieces of emotional art through an online shop, so that users may have fun purchasing and using multiple pieces of emotional art according to their situations and tastes.

In the meantime, as the signage device 100 has not yet moved significantly beyond its conventional role as an advertising board, various business models targeting an operator of the signage device 100 are under development, but there are no business models targeting users exposed to the signage device 100. An emotional art service provision system for a signage device 100 according to an embodiment of the present disclosure is implemented to enable individual users exposed to the signage device 100 to share content to the signage device 100, and sells emotional art that may be inserted into content or utilized as content itself when the content is created, thereby serving as a revenue model targeting individual users in the operation of the signage device 100.

Hereinafter, each of the elements constituting an emotional art service provision system for a signage device 100 according to an embodiment of the present disclosure will be described in detail with reference to FIG. 1.

The signage device 100 may output content including emotional art through the display panel. That is, the signage device 100 may output content in various multimedia forms, such as photos, text, and video, and may output the emotional art as a component of content or as content.

Herein, the signage device 100 may be installed at a location, such as a tourist spot or a store, in which people stay for a particular period of time or a location with a large transient population, and people may transmit content that they want to share with others to the signage device 100 for sharing with the others. In this way, sharing content, such as photos or messages, through the signage device 100 allows people to have fun by viewing thoughts, feelings, or photos from others in the same space, and to communicate with other people nearby in real time, whereby online communication via social media may be extended to offline communication to enrich offline communication.

According to an embodiment, the signage device 100 is not installed at a location accessible to an unspecified number of people, but rather in a location accessible to members of a particular group, such as a family, school, church, company, and apartment, thus enabling the group members to share content through signage device 100. In this way, by sharing content to the signage device 100, the group members may view the content together through the signage device 100 and naturally communicate with each other, as opposed to viewing their personal terminals individually. In addition, the group members may feel a new sense of excitement and fun while viewing the content through the signage device 100, which is generally larger in size than the personal terminals, and may feel a strong sense of connection to each other and fellowship may be strengthened.

In an emotional art service provision system for a signage device 100 according to an embodiment of the present disclosure, while users may share content through the signage device 100 as described above, emotional art created for the signage device 100 is shared to the signage device 100 to express the users' emotions or situations easily and quickly in a compressed way. Herein, the content may include a single piece of emotional art, but may further include a photo and text in addition to the emotional art. For example, the content may be composed of a photo or video, and text of a predetermined length or less, or composed of emotional art and text of a predetermined length or less. That is, since the content is output through the display panel of the signage device 100, visual compositions, such as a photo or video, and emotional art, are based so that the details of the content is intuitively understood with a brief glance at the display screen. In addition, the content may include a plurality of photos. For example, several photos taken at a particular restaurant and emotional art representing impressions of the photos may be composed into one piece of content. The several photos may include text for each photo.

The service server 200 may store emotional art data created for the signage device 100, may sell emotional art through an online shop, and may perform control so that emotional art purchased by a user is output to the signage device 100 at the user's request. That is, the service server 200 may manage the signage device 100 over the network, and may sell emotional art to a user who accesses the service server 200 through the signage device 100 or the user terminal 300.

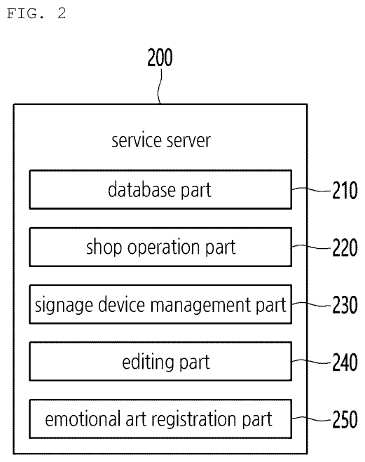

Herein, the network may be a wired network, such as a local area network (LAN), a wide area network (WAN), or a value-added network (VAN), or any types of wireless networks, such as a mobile radio communication network, a satellite network, Bluetooth, wireless broadband Internet (WiBro), High Speed Downlink Packet Access (HSDPA), long-term evolution (LTE), and 3/4/5/6th-generation mobile telecommunication (3/4/5/6G). A detailed configuration of the service server 200 will be described later with reference to FIG. 2.

The user terminal 300 may purchase emotional art and request the signage device 100 to output the emotional art. More specifically, the user terminal 300 may perform various functions related to viewing, purchasing, and editing emotional art, and creating and uploading content.

Herein, the user terminal 300 may be implemented as a user's personal electronic device, but the signage device 100 may serve as the user terminal 300 if the signage device 100 is in a form that is capable of interacting with a user. That is, a user may purchase emotional art and upload content with a personal terminal as well as the signage device 100 of a kiosk type.

Herein, examples of the electronic device may include at least one of the following: a smartphone, a tablet personal computer (PC), a mobile phone, a video phone, an e-book reader, a desktop PC, a laptop PC, a netbook computer, a workstation, a server, a personal digital assistant (PDA), a media box, a game console, an electronic dictionary, and a wearable device. Examples of the wearable device may include at least one of the following: an accessory type (e.g., a watch, ring, bracelet, anklet, necklace, glasses, contact lens, or a head-mounted device (HMD)), a fabric or clothing-integrated type (e.g., electronic clothing), a body-attachable type (e.g., a skin pad or tattoo), and an implantable circuit. In various embodiments, the electronic device is not limited to the aforementioned devices, and may be a combination of two or more of the aforementioned various devices.

The user terminal 300 may access the service server 200 through a web application, a web browser, or an application to purchase and upload emotional art for output to the signage device 100. In addition, the user terminal 300 may execute an editing function for editing emotional art or creating content. The editing function may include photo editing, text editing, and video editing functions that the service server 200 provides or an application of the user terminal 300 provides.

In the meantime, the signage device 100 may display, through the display panel, a QR code storing a link to access the service server 200 for sharing content through the signage device 100. That is, the QR code and instructions for use may be displayed on the display panel so that a user who views the signage device 100 and wants to share his or her content may easily understand how to share, and the user may easily access the service server 200 by scanning the displayed QR code with the user terminal 300.

FIG. 2 is a diagram illustrating a detailed configuration of a service server 200, in an emotional art service provision system for a signage device 100 according to an embodiment of the present disclosure. As shown in FIG. 2, a service server 200 of an emotional art service provision system for a signage device 100 according to an embodiment of the present disclosure may include a database part 210, a shop operation part 220, and a signage device management part 230, and may further include an editing part 240 and an emotional art registration part 250.

The database part 210 may store emotional art data. Herein, the database part 210 may store the emotional art data by classifying the emotional art data into categories including the size of emotional art and an event type. Herein, the emotional art data may mean data for outputting emotional art, and the emotional art may be still or animated digital objects. For example, the database part 210 may classify emotional art by situation, such as happy birthday, thank you, and a proposal, created according to a situation, emotional art by emotion, such as joy, pleasure, depression, and sadness, and emotional art by size, such as large, medium, and small, into categories for storage.

In addition, the database part 210 may store and manage, for each signage device 100, content transmitted to each signage device 100 from the signage device management part 230, which will be described in more detail. The service server 200 may operate a webpage for each signage device 100. The content stored for each signage device 100 in the database part 210 may be uploaded to a webpage for each signage device 100, and the users may view the content through the signage device 100 as well as the webpage and input various types of feedback, such as likes and comments.

The shop operation part 220 may operate an online shop that sells emotional art. The emotional art on sale at the online shop is digital objects that are created in advance to be output to the display panel of the signage device 100, and may be uploaded by the service server 200 or may be created and uploaded by other users for sale.

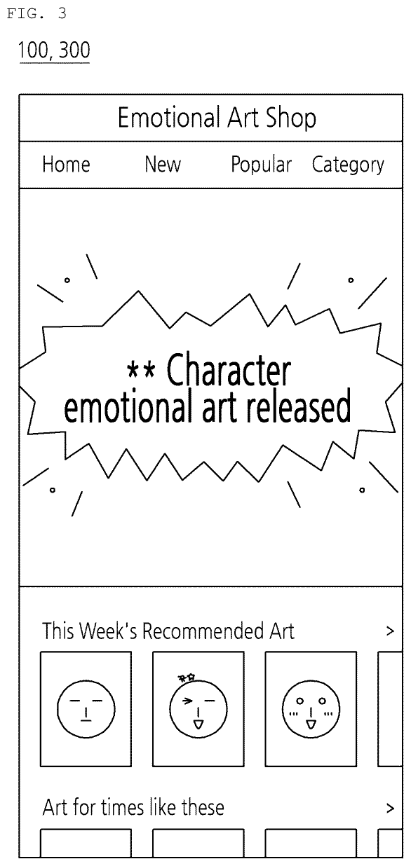

FIG. 3 is a diagram illustrating an example of an online shop operated by a shop operation part 220 of an emotional art service provision system for a signage device 100 according to an embodiment of the present disclosure. As shown in FIG. 3, a shop operation part 220 of an emotional art service provision system for a signage device 100 according to an embodiment of the present disclosure may operate an online shop for viewing and selling emotional art. A user may access the online shop through the signage device 100 or the user terminal 300, and may view and purchase the emotional art.

The shop operation part 220 may provide a payment process required for the sale of emotional art. Herein, the emotional art may have various rights for use, such as one-time use, a predetermined number of uses, and a particular period of use, and the same emotional art may have different prices depending on the number of uses or the period of use. The shop operation part 220 may register or store the emotional art purchased by a user in the user's account so that the user may use the emotional art according to the right for use when he or she wants.

The signage device management part 230 may control transmission so that the emotional art purchased by the user terminal 300 accessing the online shop is output from the signage device 100 at the user's request. More specifically, the signage device management part 230 may receive, from the user terminal 300, the selection of the emotional art to be shared and of the signage device 100 to which the emotional art is to be output, and may control transmission so that the emotional art is output from the signage device 100 when the user has the right to share content to the signage device 100. The signage device 100 may output the content uploaded by the user for sharing, and may share the user's emotions effectively through the emotional art.

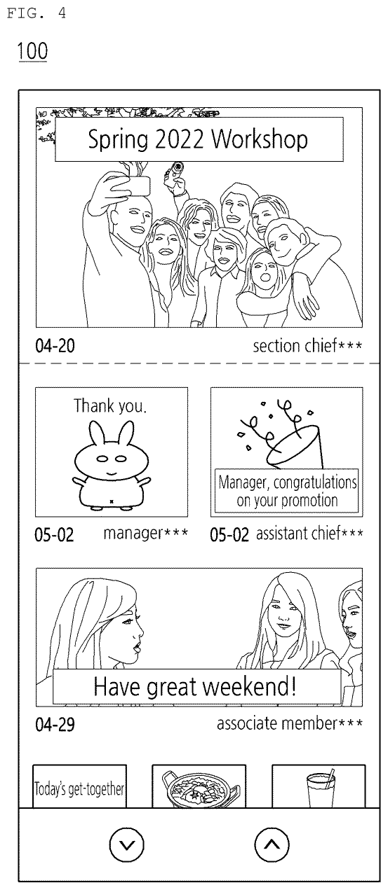

FIG. 4 is a diagram illustrating an example of a display screen of a signage device 100 in which content is output, in an emotional art service provision system for a signage device 100 according to an embodiment of the present disclosure. As shown in FIG. 4, a signage device 100 of an emotional art service provision system for a signage device 100 according to an embodiment of the present disclosure may output the content uploaded by a user under the control of the signage device management part 230. That is, as shown in FIG. 4, various types of content, such as a workshop photo, a promotion congratulatory message (“Manager, congratulations on your promotion”) from a team member, a reply message (“Thank you”) in response to the promotion congratulatory message, and weekend greeting (“Have a great weekend!”), may be output to the signage device 100 installed in the company and may be shared with coworkers.

Herein, the promotion congratulatory message and the reply message in response thereto consist of emotional art, and the other content consist of photos and messages. That is, when a user who recognizes a team member's promotion leaves a congratulatory message, rather than simply leaving a message, the user may purchase emotional art expressing congratulations, add a message, such as “Manager, congratulations on your promotion”, to the emotional art, create content, and share the content through the signage device 100. In addition, in response to the congratulations, emotional art expressing gratitude may be purchased and uploaded, whereby emotions of congratulations and gratitude may be expressed quickly and in compressed and enriched ways.

As shown in FIG. 4, multiple pieces of content may be simultaneously output to the display panel of the signage device 100. That is, in general, the screen of a signage device 100 is larger than that of a personal terminal, such as a mobile terminal or a tablet PC, so a plurality of pieces of content may be simultaneously displayed. In addition, there may be various layouts of the display screen of the signage device 100, and layouts, such as the size or placement of displayed content, may be flexibly configured to provide additional enjoyment.

According to an embodiment, when one piece of content includes a plurality of images (photos or pieces of emotional art), the plurality of images may be repeatedly displayed in sequence in one content frame. For example, the workshop content displayed at the top of FIG. 4 may include several photos taken at the workshop, and the several photos may be repeatedly displayed, automatically rotating at regular time intervals.

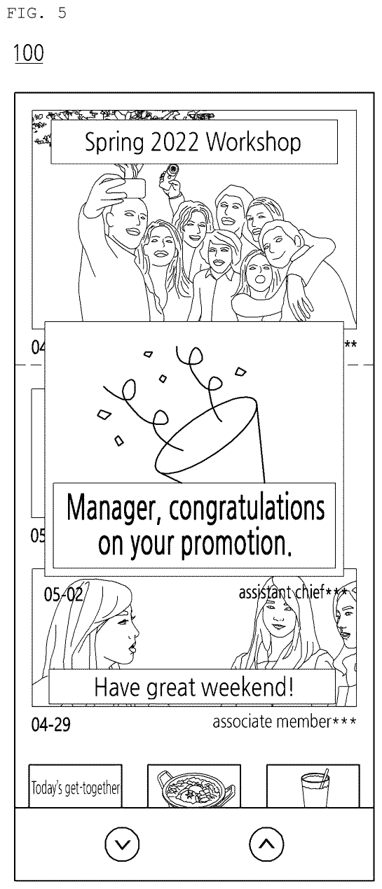

FIG. 5 is a diagram illustrating an example of a display screen of a signage device 100 in which a piece of emotional art is displayed enlarged, in an emotional art service provision system for a signage device 100 according to an embodiment of the present disclosure. As shown in FIG. 5, a signage device 100 of an emotional art service provision system for a signage device 100 according to an embodiment of the present disclosure may display, when new emotional art is uploaded or particular content is selected, the content enlarged. For example, if the signage device 100 is capable of user interaction, such as touch, when the promotion congratulatory content including emotional art is selected on the display screen of the signage device 100 as shown in FIG. 4, the content is displayed enlarged so that the details, such as emotional art, a message, a creation date, and a creator, are easily viewed as shown in FIG. 5.

In the meantime, the signage device 100 may output content in order of creation or in order of popularity or both. That is, the most recently created content may be exposed at the top, and the content with the most feedback, such as views, selections, and likes, may be exposed at the top. In addition, content may be output in a form in which the order of creation and the order of popularity are combined. For example, the display screen of the signage device 100 may be operated by being divided into an area in which content is output in order of popularity and an area in which content is output in order of creation. In the example shown in FIG. 4, popular content, such as a workshop photo, may be output separately at the top, and under the popular content, content may be output in order of creation. Herein, at the top where popular content is output, a particular number of pieces of content may be changed and displayed in order of popularity.

The editing part 240 may provide an editing tool for creating content, and a user may edit the purchased emotional art through the editing tool. More specifically, the editing part 240 may edit configurations of emotional art that are preset to be editable. That is, the emotional art is digital objects with creators, and is a means for expressing emotions quickly and effectively, and may allow limited editing of only parts preset by creators, for example, inserting text, such as messages or dates, or adjusting size. For example, the content displayed enlarged as shown in FIG. 5 is a result of editing in which text “Manager, congratulations on your promotion” is added to the firecracker-shaped emotional art.

In the meantime, the editing tool that the editing part 240 provides may include a tool for editing photos, text, or video to create content for sharing through the signage device 100. More specifically, the size and shape of a photo or the font and length of text may be specific to content for the signage device 100. Various filters, stickers, and images for editing a photo may be provided. Various tools for selecting and applying the size, color, font, and position of text may be provided. In addition, the editing part 240 may provide a preview function to a user terminal 300 so that what the created content will look like may be viewed in advance when the created content is output to the signage device 100.

The emotional art registration part 250 may receive and verify user-created emotional art to register the user-created emotional art as a product in an online shop operated by the shop operation part 220. That is, the online shop operated by the shop operation part 220 registers emotional art created by users personally as products for sale, so that the users may act as creators of the emotional art. A portion of the proceeds from the sale of the emotional art may be paid to the users who created the emotional art. This this, various pieces of emotional art may be distributed, and the users act as creators and earn additional income.

As described above, according to an emotional art service provision system for a signage device 100 proposed in the present disclosure, emotional art, which is digital objects expressing users' emotions by using graphics, is on sale for use on the signage device 100, and the emotional art purchased by users is controlled to be output to the signage device 100 at the users' requests, so that the signage device 100 may share the users' emotions effectively through the emotional art, the users may have fun purchasing and using various pieces of emotional art, and the emotional art service provision system may serve as a revenue model targeting the users in the operation of the signage device 100.

In the meantime, the present disclosure may include a computer-readable recording medium including program commands for performing operations implemented by various communication terminals. Examples of the computer-readable recording medium include magnetic recording media such as hard disks, floppy disks and magnetic tapes; optical data storage media such as CD-ROMs or DVD-ROMs; magneto-optical media such as floptical disks; and hardware devices, such as read-only memory (ROM), random-access memory (RAM), and flash memory, which are particularly structured to store and implement the program instruction.

The computer-readable recording medium may include program commands, data files, data structures, and the like separately or in combinations. Herein, the program commands being recorded in the computer-readable medium may correspond to a program command that is specifically designed and configured for the embodiments of the present disclosure, or the program command may correspond to a program command that is disclosed and available to anyone skilled in or related to computer software. For example, the program commands may include machine language codes, which are created by a compiler, as well as high-level language codes, which may be executed by a computer by using an interpreter.

Various modifications or applications of the above-described present disclosure may be made by those skilled in the art to which the present disclosure belongs, and the scope of the technical idea according to the present disclosure should be defined by the following claims.

1. An emotional art service provision system for a signage device (100), wherein the emotional art service provision system enables individual users exposed to the signage device (100) to share content to the signage device (100) and provides emotional art, which is digital objects expressing the users' emotions by using graphics, for use in the signage device (100), the emotional art service provision system comprising:
the signage device (100) configured to output the content including the emotional art through a display panel thereof;
a service server (200) configured to store emotional art data created for the signage device (100), sell the emotional art through an online shop, and perform control so that the emotional art purchased by the users exposed to the signage device (100) is output to the signage device (100) at the users' requests; and
user terminals (300) configured to purchase the emotional art and request the signage device (100) to output the emotional art,
wherein the service server (200) comprises:
a database part (210) configured to store the emotional art data;
a shop operation part (220) configured to operate the online shop selling the emotional art; and
a signage device management part (230) configured to control transmission so that the emotional art purchased by the user terminals (300) accessing the online shop is output from the signage device (100) at the users' requests,
the signage device (100) is configured to
output the content uploaded by the users for sharing, and share the users' emotions through the emotional art, and
the signage device (100) is configured to
output the content in order of creation or in order of popularity or both.

2. The emotional art service provision system of claim 1, wherein the service server (200) further comprises
an editing part (240) configured to provide an editing tool for creating the content, and edit the emotional art purchased by the users, through the editing tool.

3. The emotional art service provision system of claim 2, wherein the editing part (240) is configured to
edit a preset editable configuration of the emotional art.

4. The emotional art service provision system of claim 1, wherein the service server (200) further comprises
an emotional art registration part (250) configured to receive and verify user-created emotional art to register the user-created emotional art as a product in the online shop operated by the shop operation part (220).

5. The emotional art service provision system of claim 1, wherein the database part (210) is configured to
store the emotional art data by classifying the emotional art data into categories including a size of the emotional art and an event type.

6. The emotional art service provision system of claim 1, wherein the emotional art is
still or animated digital objects.

7. The emotional art service provision system of claim 1, wherein the signage device management part (230) is configured to
receive, from the user terminals (300), selection of the emotional art to be shared and of the signage device (100) to which the emotional art is to be output, and control transmission so that the emotional art is output from the signage device (100) when the users have rights to share the content to the signage device (100).
